(19) United States
(12) Patent Application Publication
(10) Pub. No.: US 2016/0053831 A1
(43) Pub. Date: Feb. 25, 2016

(54) ONE-WAY CLUTCH DEVICE

(71) Applicant: AISIN AW CO., LTD., Aichi (JP)

(72) Inventors: Satoru KASUYA, Nishio (JP); Masashi KITO, Anjo (JP); Yuichi SEKI, Okazaki (JP); Ryosuke KONDO, Anjo (JP)

(73) Assignee: AISIN AW CO., LTD., Anjo-shi, Aichi-ken (JP)

(21) Appl. No.: 14/778,773

(22) PCT Filed: Mar. 31, 2014
(86) PCT No.: PCT/JP2014/059516

§ 371 Date: Sep. 21, 2015

(30) Foreign Application Priority Data
Apr. 23, 2013 (JP) 2013-090591

(51) Int. Cl. F16D 41/064; F16D 47/04

(52) U.S. Cl. CPC F16D 41/064; F16D 47/04

(57) ABSTRACT

A one-way clutch device that includes a radially inner rotary member having a first oil passage formed to extend in a radial direction; and a radially outer rotary member that rotates about a rotational axis about which the radially inner rotary member also rotates, the radially outer rotary member being disposed on a radially outer side with respect to the radially inner rotary member.

### TECHNICAL FIELD

The present disclosure relates to a one-way clutch device.

### BACKGROUND ART

There is known a lubricating structure for a one-way clutch including an inner race, an outer race, a roller disposed between the inner race and the outer race, and a lubricating oil passage formed in the inner race and having one end opening in a rolling surface of the roller to supply oil from an opening at the other end to the side of the one end (see Patent Document 1, for example).

### RELATED-ART DOCUMENTS

### Patent Documents

[Patent Document 1] Japanese Patent Application Publication No. 2007-16914 (JP 2007-16914 A)

### SUMMARY OF THE INVENTION

### Problem to be Solved by the Invention

In the configuration described in Patent Document 1 described above, an inclined portion (ramp) is formed on the inner peripheral surface of the outer race, and the roller is stuck between the inclined portion of the outer race and the inner race in accordance with the rotational direction of the inner race to stop (lock) relative rotation between the inner race and the outer race.

In the configuration described in Patent Document 1 described above, the outer race is always stationary. In a configuration in which a radially outer rotary member and a radially inner rotary member are rotatable while being locked, however, a centrifugal force acts on the roller to urge the roller radially outward during such rotation. This means that the roller is urged in the direction in which a gap of the inclined portion in the radial direction is larger, and it is necessary to increase the spring force of a spring that urges the roller toward the side on which the roller is stuck in order to maintain a state in which the radially outer rotary member and the radially inner rotary member are rotated while being locked. This may result in an increase in size and cost of the spring due to an increase in spring force and degradation in fuel efficiency due to an increase in drag torque generated when the radially outer rotary member and the radially inner rotary member are unlocked. Therefore, in the configuration in which the radially outer rotary member and the radially inner rotary member are rotatable while being locked, it is desirable to form an inclined portion on the side of the radially inner rotary member.

In order to form an inclined portion on the side of the radially inner rotary member, it is conceivable to form an inclined portion on the outer peripheral surface of the radially inner rotary member itself. With this method, however, it is not easy to assemble a holder to the outer peripheral surface of the rotary member formed with the inclined portion.

On the contrary, a shell formed with an inclined portion may be press-fitted with the outer peripheral surface of the radially inner rotary member. This allows the shell to be press-fitted with the radially inner rotary member after assembling the roller and the holder to the shell, which provides improved assemblability. When such a shell is press-fitted with the outer peripheral surface of the radially inner rotary member, however, the outer peripheral surface of the radially inner rotary member is covered by the shell, which makes it difficult to supply lubricating oil to the roller by way of the radially inner rotary member.

In view of the foregoing, it is an object of the present disclosure to provide a one-way clutch device that has a configuration in which a radially outer rotary member and a radially inner rotary member are rotatable in a locked state, that provides improved assemblability, and that enables supply of lubricating oil to a roller.

### Means for Solving the Problem

An aspect of the present disclosure provides a one-way clutch device (1, 2, 1A, 2A) including:

a radially inner rotary member (10, 20) having a first oil passage (12, 26) formed to extend in a radial direction;

a radially outer rotary member (20, 50) that rotates about a rotational axis about which the radially inner rotary member (10, 20) also rotates, the radially outer rotary member (20, 50) being disposed on a radially outer side with respect to the radially inner rotary member (10, 20);

a shell (30, 30A, 60) disposed between the radially inner rotary member (10, 20) and the radially outer rotary member (20, 50) in the radial direction and press-fitted with an outer periphery of the radially inner rotary member (10, 20), the shell (30, 30A, 60) having a second oil passage (32, 62) formed to extend in the radial direction to communicate with the first oil passage (12, 26) and an inclined portion (34, 340) formed on an outer peripheral surface of the shell (30, 30A, 60), a distance of the inclined portion (34, 340) from an inner peripheral surface of the radially outer rotary member (20, 50) in the radial direction being varied in a circumferential direction;

a roller (40, 400) housed between the inner peripheral surface of the radially outer rotary member (20, 50) and the inclined portion (34, 340) of the shell (30, 30A, 60);

an elastic member (42) that urges the roller (40, 400) toward a side toward which the distance of the inclined portion (34, 340) of the shell (30, 30A, 60) from the inner peripheral surface of the radially outer rotary member (20, 50) in the radial direction becomes smaller; and

a holder (44, 440) that holds the roller (40, 400) and the elastic member (42).

### Effects of the Invention

According to the present disclosure, it is possible to obtain a one-way clutch device that has a configuration in which a radially outer rotary member and a radially inner rotary member are rotatable in a locked state, that provides improved assemblability, and that enables supply of lubricating oil to a roller.

### BRIEF DESCRIPTION OF THE DRAWINGS

FIG. 1 is a sectional view of a part of a vehicle drive device 100 incorporating a one-way clutch device 1 according to an embodiment.

FIG. 2 is a schematic illustration of the one-way clutch device 1.

FIG. 3 is an enlarged view of a part of FIG. 1.

FIG. 4 illustrates an example of a configuration taken along the A-A cross section of FIG. 1.

FIG. 5 illustrates another example of the configuration taken along the A-A cross section of FIG. 1.

FIG. 6 illustrates an example of a configuration taken along the B-B cross section of FIG. 1.

FIG. 7 illustrates another example of the configuration taken along the B-B cross section of FIG. 1.

FIG. 8 is a sectional view of a part of a vehicle drive device 100A incorporating a first one-way clutch device 1A and a second one-way clutch device 2A according to another embodiment.

FIG. 9 illustrates an example of a shell 30A.

FIG. 10 illustrates a manner of variation in thickness of the shell 30A and a shell 30 in the axial direction.

FIG. 11 is a schematic diagram of a vehicle drive device 100B incorporating the one-way clutch device 1 and a one-way clutch device 2 in another aspect.

FIG. 12 is a schematic diagram of a vehicle drive device 100C incorporating the one-way clutch device 1 and the one-way clutch device 2 in still another aspect.

### MODES FOR CARRYING OUT THE INVENTION

Various embodiments will be described in detail below with reference to the accompanying drawings.

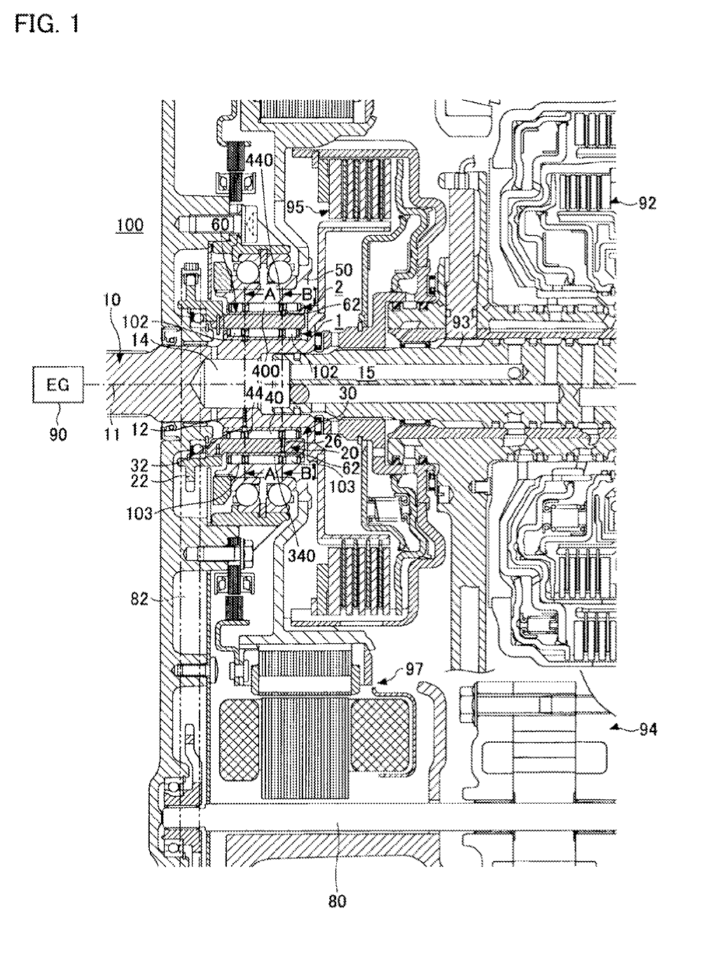

FIG. 1 is a sectional view of a part of a vehicle drive device 100 incorporating a one-way clutch device 1 according to an embodiment. In the following description, the radial direction, the circumferential direction, and the axial direction are defined with reference to an axis 11, and the radially inner side and the radially outer side are defined about the axis 11. For example, the radially inner side refers to a side closer to the axis 11 in the radial direction of the axis 11.

First, a vehicle drive device 100 illustrated in FIG. 1 will be described briefly. A first rotary member 10 is an input shaft coupled to an engine 90, and is connected to an input shaft 93 of a speed change mechanism 92 via a clutch 95. A motor 97 has an output shaft (rotor) connected to the input shaft 93 of the speed change mechanism 92. When the clutch 95 is engaged, rotational torque of the motor 97 and rotational torque of the engine 90 can be transferred to the input shaft 93 of the speed change mechanism 92. When the clutch 95 is disengaged, on the other hand, the engine 90 is disconnected from the input shaft 93 of the speed change mechanism 92. At this time, only rotational torque from the motor 97 can be transferred to the input shaft 93 of the speed change mechanism 92. The one-way clutch device 1 can be incorporated into a vehicle drive device of any configuration, besides the vehicle drive device 100 illustrated in FIG. 1. In the example illustrated in FIG. 1, the one-way clutch device 1 is provided between the engine 90 and the speed change mechanism 92 in the axial direction.

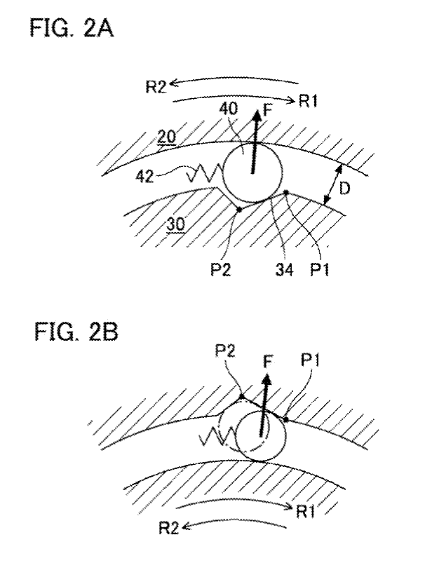

The one-way clutch device 1 includes the first rotary member 10 (an example of the radially inner rotary member), a second rotary member (an example of the radially outer rotary member) 20, a shell 30, a roller 40, an elastic member 42 (see FIG. 2), and a holder 44.

The first rotary member 10 rotates about the axis 11. In the example illustrated in FIG. 1, the first rotary member 10 is an input shaft coupled to the engine 90. Thus, the axis 11 may be coaxial with the output shaft of the engine 90. The first rotary member 10 and the engine 90 may be coupled to each other in any manner, and may be coupled to each other via a damper or directly, for example

The first rotary member 10 has a first oil passage 12 formed to extend in the radial direction. In the example illustrated in FIG. 1, the first oil passage 12 linearly extends radially outward from the outer peripheral surface of an oil passage 14 formed to extend in the axial direction in the first rotary member 10. The first oil passage 12 may be formed at a plurality of positions along the circumferential direction of the first rotary member 10. In the example illustrated in FIG. 1, the oil passage 14 communicates with an oil passage 15 formed inside the input shaft (transmission input shaft) 93 of the speed change mechanism 92. The oil passage 14 may be supplied with lubricating oil (or cooling oil) via the oil passage 15.

The second rotary member 20 rotates about the axis 11 as a rotational axis. The second rotary member 20 is disposed on the radially outer side with respect to the first rotary member 10. The second rotary member 20 may be provided so as to surround the outer peripheral side of the first rotary member 10. In the example illustrated in FIG. 1, the second rotary member 20 is an annular member, and is provided so as to surround the outer peripheral side of the first rotary member 10 which is a shaft-like member. A pump drive shaft 80 is connected to an end portion of the second rotary member 20 on the engine side via a sprocket 22 and a chain 82. Thus, rotation of the second rotary member 20 rotates the pump drive shaft 80 to drive a pump 94.

In the example illustrated in FIG. 1, the first rotary member 10 and the second rotary member 20 are connected to the engine 90 and the pump 94, respectively. However, the first rotary member 10 and the second rotary member 20 may each be connected to any component.

The shell 30 has a cylindrical shape, and is disposed between the first rotary member 10 and the second rotary member 20 in the radial direction. The shell 30 is press-fitted with the outer periphery of the first rotary member 10. Thus, the shell 30 rotates together with the first rotary member 10. The shell 30 has a second oil passage 32 formed to extend in the radial direction to communicate with the first oil passage 12. The relationship etc. of the second oil passage 32 and the first oil passage 12 will be described in detail later.

The roller 40 is disposed between the shell 30 and the second rotary member 20 in the radial direction. The function etc. of the roller 40 and the elastic member 42 is well-known, and will be discussed later with reference to FIG. 2.

The holder 44 holds the roller 40 and the elastic member 42. The holder 44 is fixed to the shell 30. The holder 44 may be formed from a resin material.

FIG. 2 is a schematic illustration of the one-way clutch device 1, in which FIG. 2A illustrates a case of the embodiment and FIG. 2B illustrates a case of a comparative example. In FIG. 2, an inclined portion (ramp) 34, the roller 40, the elastic member 42, etc. are illustrated very briefly as viewed in the axial direction. In FIG. 2, in addition, the inclined portion 34, the roller 40, the elastic member 42, etc. are illustrated as extracted for a part of the one-way clutch device 1 in the circumferential direction.

In the case of the embodiment, as schematically illustrated in FIG. 2A, the shell 30 includes the inclined portion 34 on the outer peripheral surface. The inclined portion 34 is formed such that a distance D between the outer peripheral surface of the shell 30 and the inner peripheral surface of the second rotary member 20 in the radial direction is varied in the circumferential direction. Typically, the inclined portion 34 is formed such that the distance D is gradually decreased in a predetermined first rotational direction R1. The distance D may be varied linearly, non-linearly, or in any manner along the circumferential direction. The roller 40 is disposed between the inclined portion 34 and the inner peripheral surface of the second rotary member 20.

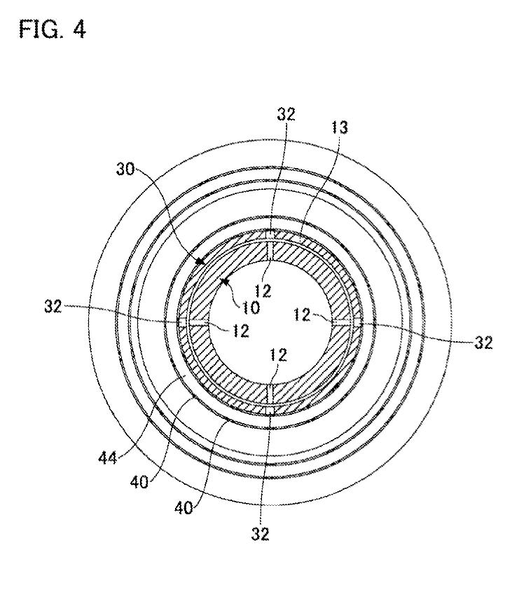

The elastic member 42 urges the roller 40 toward the side on which the distance D of the inclined portion 34 becomes smaller (that is, toward a point P1 at which the distance D of the inclined portion 34 is the smallest). The elastic member 42 may be any component such as a plate spring or a spring. The roller 40 may be paired with the inclined portion 34 and the elastic member 42. A plurality of rollers 40 may be provided in the circumferential direction of the shell 30 (see FIG. 4).

When the second rotary member 20 makes relative rotation in the first rotational direction R1 with respect to the shell 30 (first rotary member 10), the roller 40 moves toward the point P1 at which the distance D of the inclined portion 34 is the smallest. Around the point P1, the distance D is smaller than the diameter of the roller 40. Consequently, the roller 40 is stuck (restrained) as a wedge between the inclined portion 34 and the inner peripheral surface of the second rotary member 20 so that the second rotary member 20 and the shell 30 (first rotary member 10) rotate together with each other. Hereinafter, such a state is referred to also as a “locked state”.

When the second rotary member 20 makes relative rotation in a second rotational direction R2 with respect to the shell 30 (first rotary member 10), the roller 40 moves toward a point P2 at which the distance D of the inclined portion 34 is the largest against the urging force from the elastic member 42. Around the point P2, the distance D is larger than the diameter of the roller 40. Consequently, the roller 40 is freed between the inclined portion 34 and the inner peripheral surface of the second rotary member 20 so that the second rotary member 20 and the shell 30 (first rotary member 10) can freely rotate with respect to each other.

In the comparative example, as illustrated in FIG. 2B, a similar inclined portion (ramp) is formed on the inner peripheral surface of the radially outer rotary member. Also in such a case, operation of the one-way clutch function is substantially the same. In the case where the radially outer rotary member and the radially inner rotary member are rotated in the locked state, however, a centrifugal force F acts on the roller to urge the roller to move radially outward. Consequently, the roller moves toward a point P2 at which the distance D of the inclined portion 34 is the largest as indicated by the dash-and-dot line in FIG. 2B. This means that it is necessary to increase the spring force of a spring (spring corresponding to the elastic member 42) that urges the roller toward the side on which the roller is stuck in order to maintain a state in which the radially outer rotary member and the radially inner rotary member are rotated while being locked. This may result in an increase in size and cost of the spring due to an increase in spring force and degradation in fuel efficiency due to an increase in drag torque generated when the radially outer rotary member and the radially inner rotary member are unlocked.

In the embodiment, in contrast, in the case where the second rotary member 20 and the shell 30 (first rotary member 10) are rotated in the locked state, a centrifugal force F acts on the roller 40 to urge the roller 40 to move the roller 40 radially outward. Such movement is made in the direction of promoting the locked state, which does not result in the inconvenience caused in the comparative example discussed above.

Here, operation of the one-way clutch device 1 will be described with reference to FIGS. 1 and 2.

Here, by way of example, the rotational direction of the shell 30 (first rotary member 10) is determined as the second rotational direction R2. When the rotational speed of the shell 30 (first rotary member 10) on the radially inner side is lower than the rotational speed of the second rotary member 20 on the radially outer side, the second rotary member 20 makes relative rotation in the second rotational direction R2 with respect to the shell 30 (first rotary member 10). Thus, at this time, the second rotary member 20 (and hence the pump 94) is not driven by the first rotary member 10 (and hence the engine 90). When the rotational speed of the shell 30 is raised to be equal to the rotational speed of the second rotary member 20 (or is raised to be higher than the rotational speed of the second rotary member 20), the locked state is established so that the second rotary member 20 and the shell 30 (first rotary member 10) rotate together with each other. Thus, at this time, the second rotary member 20 (and hence the pump 94) is driven by the first rotary member 10 (and hence the engine 90).

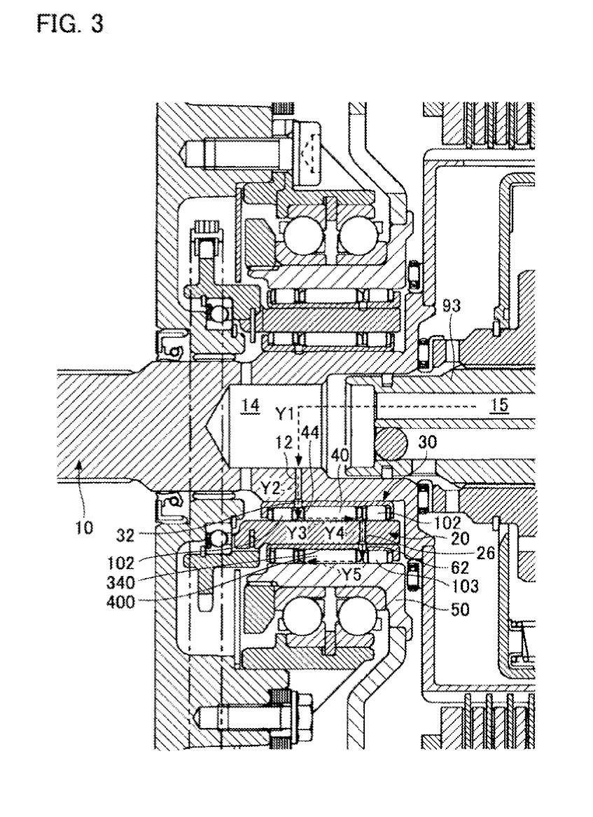

Next, the oil passages in the one-way clutch device 1 will be described with reference to FIG. 3. FIG. 3 is an enlarged view of a part of FIG. 1.

As indicated by the arrow Y1 in FIG. 3, lubricating oil introduced into the oil passage 14 in the first rotary member 10 is introduced into the first oil passage 12 in the first rotary member 10. The lubricating oil introduced into the first oil passage 12 flows radially outward in the first oil passage 12 through the action of a centrifugal force etc. to be introduced into the second oil passage 32 of the shell 30 as indicated by the arrow Y2 in FIG. 3. The lubricating oil reaches the radially outer side of the shell 30 through the second oil passage 32 to lubricate the roller 40 (see Y3 in FIG. 3).

In the embodiment, as discussed above, the inclined portion 34 is formed on the shell 30 side so that the locked state is promoted by the effect of a centrifugal force when the second rotary member 20 and the shell 30 (first rotary member 10) rotate together with each other. In this respect, it is also conceivable to form a similar inclined portion 34 on the first rotary member 10 itself and omit the shell 30. With such a configuration, however, the formability of the first rotary member 10 is degraded to increase the cost, and the assemblability of the holder 44 to the first rotary member 10 is degraded. In addition, the configuration makes it difficult to manage the one-way clutch as a single constituent part.

Thus, according to the embodiment, with the inclined portion 34 formed on the shell 30 to be press-fitted with the first rotary member 10, the shell 30 can be press-fitted with the first rotary member 10 with the holder 44 assembled to the shell 30, which provides improved assemblability. If the shell 30 is press-fitted with the outer periphery of the first rotary member 10, however, it is difficult to supply lubricating oil to the outer peripheral side of the first rotary member 10.

In this respect, in the embodiment, as discussed above, the first oil passage 12 is formed in the first rotary member 10 to extend in the radial direction and the second oil passage 32 is formed in the shell 30 to extend in the radial direction. Thus, lubricating oil can be supplied to the roller 40 from the radially inner side to the radially outer side. Consequently, the roller 40 can be lubricated using the oil passage 14 in the first rotary member 10.

In the example illustrated in FIG. 3, in addition, an opening of the second oil passage 32 on the radially outer side is positioned between the roller 40 and a bearing 102 in the axial direction. The bearing 102 is provided adjacent to the roller 40 on both sides of the roller 40 in the axial direction to provide a function of positioning between the shell 30 and the second rotary member 20 while permitting relative rotation between the shell 30 and the second rotary member 20. With such a configuration, the second oil passage 32 can be formed utilizing a region in the axial direction in which the roller 40 or the bearing 102 is not provided. That is, the second oil passage 32 can be formed while substantially maintaining the required strength of the shell 30. In this case, as illustrated in FIG. 3, lubricating oil introduced into the second oil passage 32 is supplied to a location between the roller 40 and the bearing 102 in the axial direction (an end portion of the holder 44 in the axial direction). Then, the lubricating oil flows in the axial direction as indicated by the arrow Y3 in FIG. 3 to lubricate the entire roller 40.

It should be noted, however, that an opening of the second oil passage 32 on the radially outer side may be positioned at a location other than between the roller 40 and the bearing 102 in the axial direction. For example, an opening of the second oil passage 32 on the radially outer side may be positioned in a region in which the roller 40 or the bearing 102 is disposed in the axial direction. In this case, an opening of the second oil passage 32 on the radially outer side may be provided outside the movable range of the roller 40 (that is, the inclined portion 34) in the circumferential direction, for example.

In the example illustrated in FIG. 3, in addition, an opening of the first oil passage 12 on the radially outer side and an opening of the second oil passage 32 on the radially inner side are formed at the same position in the axial direction. Consequently, the first oil passage 12 and the second oil passage 32 can efficiently communicate with each other. It should be noted, however, that an opening of the first oil passage 12 on the radially outer side and an opening of the second oil passage 32 on the radially inner side may be offset from each other in the axial direction.

FIG. 4 illustrates an example of a configuration taken along the A-A cross section of FIG. 1.

As illustrated in FIG. 4, the first oil passage 12 and the second oil passage 32 may communicate with each other via an annular oil passage 13 formed in the outer peripheral surface of the first rotary member 10. The annular oil passage 13 is preferably formed to be annular over the entire circumference of the outer peripheral surface of the first rotary member 10. In the case where the oil passage 13 is formed over the entire circumference of the outer peripheral surface of the first rotary member 10, the first oil passage 12 and the second oil passage 32 can communicate with each other irrespective of the angular relationship (positional relationship in the rotational direction) with which the shell 30 is press-fitted with the first rotary member 10. For example, in the example illustrated in FIG. 4, the shell 30 is press-fitted with the first rotary member 10 with such an angular relationship that the first oil passage 12 and the second oil passage 32 face each other in the radial direction. However, the first oil passage 12 and the second oil passage 32 can communicate with each other via the oil passage 13 even in the case where the shell 30 is press-fitted with the first rotary member 10 with such an angular relationship that the first oil passage 12 and the second oil passage 32 do not face each other in the radial direction.

In the example illustrated in FIG. 4, the oil passage 13 is formed in the outer peripheral surface of the first rotary member 10. Alternatively or additionally, however, an annular oil passage may be formed in the inner peripheral surface of the shell 30.

In the example illustrated in FIG. 4, in addition, the oil passage 13 is formed over the entire circumference of the outer peripheral surface of the first rotary member 10. However, the oil passage 13 may be formed in only a part of the outer peripheral surface of the first rotary member 10 in the circumferential direction. In this case, the shell 30 may be press-fitted with the first rotary member 10 at such an angular relationship that the second oil passage 32 communicates with the oil passage 13.

In the example illustrated in FIG. 4, in addition, a plurality of first oil passages 12 and second oil passages 32 are formed along the circumferential direction, the first oil passages 12 and the second oil passages 32 being the same in number as each other. However, the first oil passages 12 and the second oil passages 32 may be different in number from each other. In the example illustrated in FIG. 4, in addition, the first oil passages 12 and the second oil passages 32 are formed at equal intervals along the circumferential direction. However, the first oil passages 12 and the second oil passages 32 may be formed at unequal intervals. In the example illustrated in FIG. 4, in addition, a plurality of first oil passages 12 and second oil passages 32 are preferably formed. However, only a single first oil passage 12 and a single second oil passage 32 may be formed.

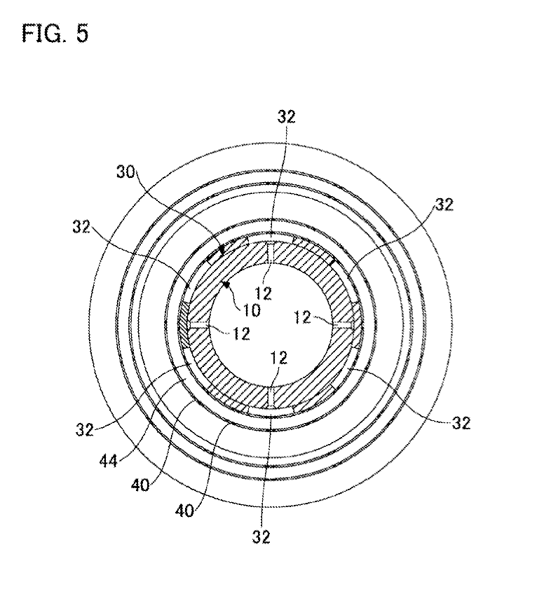

FIG. 5 illustrates another example of the configuration taken along the A-A cross section of FIG. 1.

As illustrated in FIG. 5, the first oil passage 12 and the second oil passage 32 may directly communicate with each other. In this case, the arrangement, the number, etc. of the first oil passage 12 and the second oil passage 32 may be determined such that the first oil passage 12 and the second oil passage 32 can communicate with each other irrespective of the angular relationship with which the shell 30 is press-fitted with the first rotary member 10. In the example illustrated in FIG. 5, for example, the first oil passages 12 are formed at four locations at intervals of 90 degrees, and the second oil passages 32 are formed at six locations at intervals of 30 degrees. In addition, the opening width of each second oil passage 32 has an angle of 30 degrees. Consequently, if the first rotary member 10 is rotated counterclockwise from the angular relationship of the shell 30 with respect to the first rotary member 10 illustrated in the drawing, for example, the first oil passages 12 at the upper and lower portions of FIG. 5 are brought into a non-communicated state, and the first oil passages 12 at the left and right portions of FIG. 5 are brought into a communicated state at the same time.

The configuration of the first oil passage 12 and the second oil passage 32 which can communicate with each other irrespective of the angular relationship of the shell 30 with respect to the first rotary member 10 is not limited to the specific configuration illustrated in FIG. 5. For example, the configuration of the first oil passages 12 and the second oil passages 32 may be reversed from the configuration illustrated in FIG. 5. That is, the second oil passage 32 may be formed at four locations at intervals of 90 degrees, and the first oil passage 12 may be formed at six locations at intervals of 30 degrees to have an angular width of 30 degrees.

Next, a second one-way clutch device 2 of the vehicle drive device 100 illustrated in FIG. 1 will be described with reference to FIG. 1 again.

In the vehicle drive device 100 illustrated in FIG. 1, the second one-way clutch device 2 is provided in corporation with the one-way clutch device 1 (hereinafter referred to also as a first one-way clutch device 1) discussed above. However, the two one-way clutch devices may be provided independently. In the example illustrated in FIG. 1, as with the first one-way clutch device 1, the second one-way clutch device 2 is provided between the engine 90 and the speed change mechanism 92 in the axial direction.

As illustrated in FIG. 1, the second one-way clutch device 2 includes the second rotary member 20 (an example of the radially inner rotary member), a third rotary member 50 (an example of the radially outer rotary member), a second shell 60, a roller 400, an elastic member, and a holder 440. The configuration of the second shell 60, the roller 400, the elastic member, and the holder 440 may be substantially the same as that of the roller 40, the elastic member, and the holder 44 of the first one-way clutch device 1 discussed above mainly except that the second oil passage 32 of the shell 30 is replaced with a fourth oil passage 62 of the second shell 60. Thus, the second shell 60 includes an inclined portion 340 on the outer peripheral surface side. It should be noted, however, that the direction of inclination of the inclined portion 340 is opposite to that of the inclined portion 34. That is, the inclined portion 340 is formed such that the distance between the outer peripheral surface of the second shell 60 and the inner peripheral surface of the third rotary member 50 in the radial direction is gradually decreased toward the second rotational direction R2 (see FIG. 2).

The second rotary member 20 is also a constituent element of the first one-way clutch device 1, and rotates about the axis 11 as a rotational axis as discussed above. The second rotary member 20 has a third oil passage 26 formed to extend in the radial direction. In the example illustrated in FIG. 1, the third oil passage 26 linearly extends radially outward from the inner peripheral surface of the second rotary member 20. The third oil passage 26 may be formed at a plurality of positions along the circumferential direction of the second rotary member 20.

The third rotary member 50 rotates about the axis 11 as a rotational axis. The third rotary member 50 is disposed on the radially outer side with respect to the second rotary member 20. The third rotary member 50 may be provided so as to surround the outer peripheral side of the second rotary member 20. In the example illustrated in FIG. 1, the third rotary member 50 is an annular member, and is provided so as to surround the outer peripheral side of the second rotary member 20 which is an annular member. The output shaft of the motor 97 is connected to the third rotary member 50. Thus, the third rotary member 50 is rotationally driven by the motor 97.

In the example illustrated in FIG. 1, the second rotary member 20 and the third rotary member 50 are connected to the pump 94 and the motor 97, respectively. However, the second rotary member 20 and the third rotary member 50 may each be connected to any component.

The second shell 60 has a cylindrical shape, and is disposed between the second rotary member 20 and the third rotary member 50 in the radial direction. The second shell 60 is press-fitted with the outer periphery of the second rotary member 20. Thus, the second shell 60 rotates together with the second rotary member 20. The second shell 60 has the fourth oil passage 62 formed to extend in the radial direction to communicate with the third oil passage 26 of the second rotary member 20. The relationship etc. between the third oil passage 26 and the fourth oil passage 62 may be the same as the relationship etc. between the first oil passage 12 and the second oil passage 32 discussed above.

In the example illustrated in FIG. 1, the third oil passage 26 and the fourth oil passage 62 extend perpendicularly with respect to the axial direction. However, the third oil passage 26 and the fourth oil passage 62 may extend obliquely with respect to the axial direction.

Here, operation of the second one-way clutch device 2 will be described.

Here, by way of example, the rotational direction of the second shell 60 (second rotary member 20) is determined as the second rotational direction R2 (see FIG. 2). When the rotational speed of the second shell 60 (second rotary member 20) on the radially inner side is higher than the rotational speed of the third rotary member 50 on the radially outer side, the third rotary member 50 makes relative rotation in the first rotational direction R1 with respect to the second shell 60 (second rotary member 20). Thus, at this time, the second rotary member 20 (and hence the pump 94) is not driven by the third rotary member 50 (and hence the motor 97). When the rotational speed of the third rotary member 50 is raised to be equal to the rotational speed of the second rotary member 20 (or is raised to be higher than the rotational speed of the second rotary member 20), the locked state is established so that the second rotary member 20 and the second shell 60 (third rotary member 50) rotate together with each other. Thus, at this time, the second rotary member 20 (and hence the pump 94) is driven by the third rotary member 50 (and hence the motor 97).

Consequently, the one-way clutch mechanisms disposed on both sides of the second rotary member 20 in the radial direction cooperate with each other so that one of the first rotary member 10 (and hence the engine 90) and the third rotary member 50 (and hence the motor 97) with a higher rotational speed rotates together with the sprocket 22. Thus, the pump 94 is driven by one of the engine 90 and the motor 97 with a higher rotational speed.

Next, the oil passages in the one-way clutch device 2 will be described with reference to FIG. 3 again.

Lubricating oil that flows in the axial direction as indicated by the arrow Y3 in FIG. 3 is introduced into the third oil passage 26 of the second rotary member 20 as indicated by the arrow Y4 in FIG. 3. The lubricating oil introduced into the third oil passage 26 of the second rotary member 20 flows radially outward through the action of a centrifugal force etc. to be introduced into the fourth oil passage 62 of the second shell 60 as indicated by the arrow Y4 in FIG. 3. The lubricating oil reaches the radially outer side of the second shell 60 through the fourth oil passage 62 to lubricate the roller 400 (see Y5 in FIG. 3).

In the embodiment, as discussed above, the inclined portion 340 is formed on the second shell 60 side so that the locked state is promoted by the effect of a centrifugal force when the second rotary member 20 and the second shell 60 (third rotary member 50) rotate together with each other. In this respect, it is also conceivable to form a similar inclined portion 340 on the second rotary member 20 itself and omit the second shell 60. With such a configuration, with such a configuration, however, the formability of the second rotary member 20 is degraded to increase the cost, and the assemblability of the holder 440 to the second rotary member 20 is degraded. In addition, the configuration makes it difficult to manage the one-way clutch as a single constituent part.

Thus, according to the embodiment, with the inclined portion 340 formed on the second shell 60 to be press-fitted with the second rotary member 20, the second shell 60 can be press-fitted with the second rotary member 20 with the holder 440 assembled to the second shell 60, which provides improved assemblability. If the second shell 60 is press-fitted with the outer periphery of the second rotary member 20, however, it is difficult to supply lubricating oil to the outer peripheral side of the second rotary member 20.

In this respect, in the embodiment, as discussed above, the third oil passage 26 is formed in the second rotary member 20 to extend in the radial direction and the fourth oil passage 62 is formed in the second shell 60 to extend in the radial direction. Thus, lubricating oil can be supplied to the roller 400 from the radially inner side to the radially outer side. Consequently, the roller 400 can be lubricated using the oil passage 14 in the first rotary member 10.

In the example illustrated in FIG. 3, in addition, an opening of the fourth oil passage 62 on the radially outer side is positioned between the roller 400 and a bearing 103 in the axial direction. The bearing 103 is provided adjacent to the roller 400 on both sides of the roller 40 in the axial direction to provide a function of positioning between the second shell 60 and the third rotary member 50 while permitting relative rotation between the second shell 60 and the third rotary member 50. With such a configuration, the fourth oil passage 62 can be formed utilizing a region in the axial direction in which the roller 400 or the bearing 103 is not provided. That is, the fourth oil passage 62 can be formed while substantially maintaining the required strength of the second shell 60. In this case, as illustrated in FIG. 3, lubricating oil introduced into the fourth oil passage 62 is supplied to a location between the roller 400 and the bearing 103 in the axial direction (an end portion of the holder 440 in the axial direction). Then, the lubricating oil flows in the axial direction as indicated by the arrow Y5 in FIG. 3 to lubricate the entire roller 400.

It should be noted, however, that an opening of the fourth oil passage 62 on the radially outer side may be positioned at a location other than between the roller 400 and the bearing 103 in the axial direction. For example, an opening of the fourth oil passage 62 on the radially outer side may be positioned in a region in which the roller 400 or the bearing 103 is disposed in the axial direction. In this case, an opening of the fourth oil passage 62 on the radially outer side may be provided outside the movable range of the roller 400 (that is, the inclined portion 340) in the circumferential direction, for example.

In the example illustrated in FIG. 3, in addition, an opening of the third oil passage 26 on the radially outer side and an opening of the fourth oil passage 62 on the radially inner side are formed at the same position in the axial direction. Consequently, the third oil passage 26 and the fourth oil passage 62 can efficiently communicate with each other. It should be noted, however, that an opening of the third oil passage 26 on the radially outer side and an opening of the fourth oil passage 62 on the radially inner side may be offset from each other in the axial direction. In this case, an opening of the third oil passage 26 on the radially outer side and an opening of the fourth oil passage 62 on the radially inner side may communicate with each other via an oil passage (not illustrated) in the axial direction formed in the outer peripheral surface of the second rotary member 20 and/or the inner peripheral surface of the second shell 60. In addition, the third oil passage 26 and/or the fourth oil passage 62 may be formed at a plurality of locations offset in the axial direction.

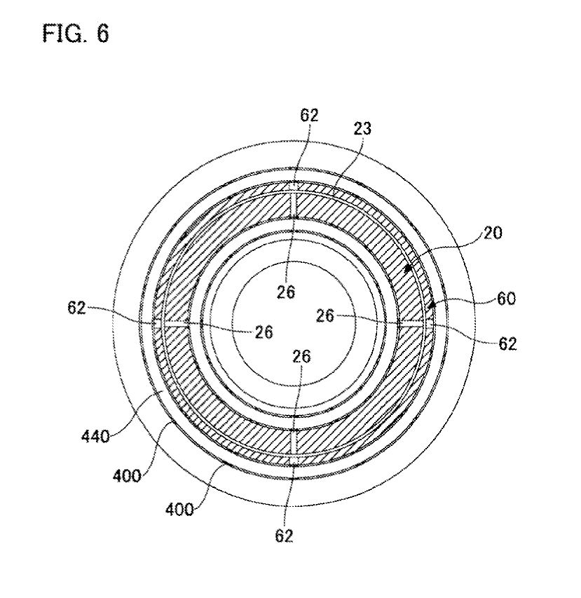

FIG. 6 illustrates an example of a configuration taken along the B-B cross section of FIG. 1.

As illustrated in FIG. 6, the third oil passage 26 and the fourth oil passage 62 may communicate with each other via an annular oil passage 23 formed in the outer peripheral surface of the second rotary member 20. The annular oil passage 23 is preferably formed to be annular over the entire circumference of the outer peripheral surface of the second rotary member 20. In the case where the oil passage 23 is formed over the entire circumference of the outer peripheral surface of the second rotary member 20, the third oil passage 26 and the fourth oil passage 62 can communicate with each other irrespective of the angular relationship (positional relationship in the rotational direction) with which the second shell 60 is press-fitted with the second rotary member 20. For example, in the example illustrated in FIG. 6, the second shell 60 is press-fitted with the second rotary member 20 with such an angular relationship that the third oil passage 26 and the fourth oil passage 62 face each other in the radial direction. However, the third oil passage 26 and the fourth oil passage 62 can communicate with each other via the oil passage 23 even in the case where the second shell 60 is press-fitted with the second rotary member 20 with such an angular relationship that the third oil passage 26 and the fourth oil passage 62 do not face each other in the radial direction.

In the example illustrated in FIG. 6, the oil passage 23 is formed in the outer peripheral surface of the second rotary member 20. Alternatively or additionally, however, an annular oil passage may be formed in the inner peripheral surface of the second shell 60.

In the example illustrated in FIG. 6, in addition, the oil passage 23 is formed over the entire circumference of the outer peripheral surface of the second rotary member 20. However, the oil passage 23 may be formed in only a part of the outer peripheral surface of the second rotary member 20 in the circumferential direction. In this case, the second shell 60 may be press-fitted with the second rotary member 20 at such an angular relationship that the fourth oil passage 62 communicates with the oil passage 23.

In the example illustrated in FIG. 6, in addition, a plurality of third oil passages 26 and fourth oil passages 62 are formed along the circumferential direction, the third oil passages 26 and the fourth oil passages 62 being the same in number as each other. However, the third oil passages 26 and the fourth oil passages 62 may be different in number from each other. In the example illustrated in FIG. 6, in addition, the third oil passages 26 and the fourth oil passages 62 are formed at equal intervals along the circumferential direction. However, the third oil passages 26 and the fourth oil passages 62 may be formed at unequal intervals. In the example illustrated in FIG. 6, in addition, a plurality of third oil passages 26 and fourth oil passages 62 are preferably formed. However, only a single third oil passage 26 and a single fourth oil passage 62 may be formed.

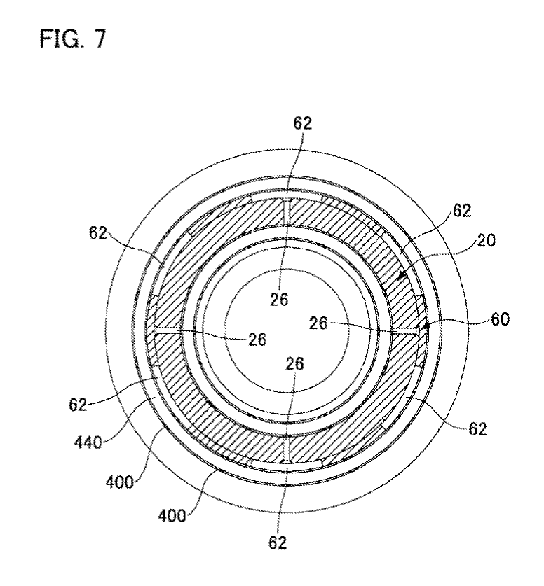

FIG. 7 illustrates another example of the configuration taken along the A-A cross section of FIG. 1.

As illustrated in FIG. 7, the third oil passage 26 and the fourth oil passage 62 may directly communicate with each other. In this case, the third oil passage 26 and the fourth oil passage 62 may be configured such that the third oil passage 26 and the fourth oil passage 62 can communicate with each other irrespective of the angular relationship with which the second shell 60 is press-fitted with the second rotary member 20. In the example illustrated in FIG. 7, for example, the third oil passages 26 are formed at four locations at intervals of 90 degrees, and the fourth oil passages 62 are formed at six locations at intervals of 30 degrees. In addition, the opening width of each fourth oil passage 62 has an angle of 30 degrees. Consequently, if the second rotary member 20 is rotated counterclockwise from the angular relationship of the second shell 60 with respect to the second rotary member 20 illustrated in the drawing, for example, the third oil passages 26 at the upper and lower portions of FIG. 7 are brought into a non-communicated state, and the third oil passages 26 at the left and right portions of FIG. 7 are brought into a communicated state at the same time.

The configuration of the third oil passage 26 and the fourth oil passage 62 which can communicate with each other irrespective of the angular relationship of the second shell 60 with respect to the second rotary member 20 is not limited to the specific configuration illustrated in FIG. 7. For example, the configuration of the third oil passages 26 and the fourth oil passages 62 may be reversed from the configuration illustrated in FIG. 7. That is, the fourth oil passage 62 may be formed at four locations at intervals of 90 degrees, and the third oil passage 26 may be formed at six locations at intervals of 30 degrees to have an angular width of 30 degrees.

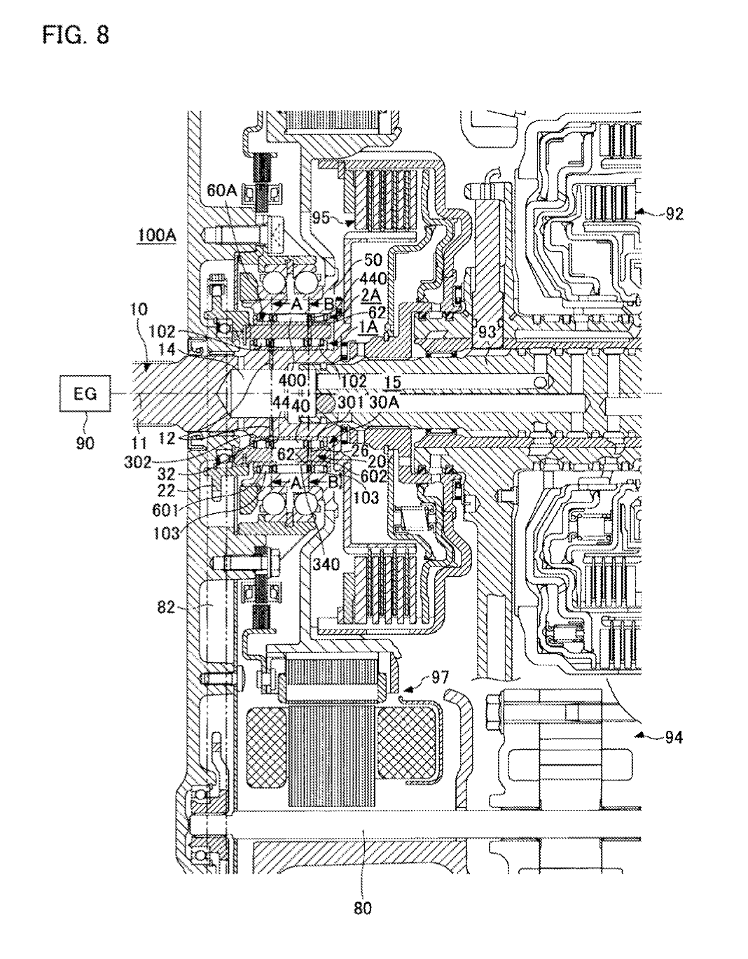

FIG. 8 is a sectional view of a part of a vehicle drive device 100A incorporating a first one-way clutch device 1A and a second one-way clutch device 2A according to another embodiment.

The first one-way clutch device 1A is substantially different from the first one-way clutch device 1 discussed above with reference to FIG. 1 etc. in that the shell 30 is replaced with a shell 30A. Similarly, the second one-way clutch device 2A is substantially different from the second one-way clutch device 2 discussed above with reference to FIG. 1 etc. in that the second shell 60 is replaced with a second shell 60A. Constituent elements of the vehicle drive device 100A that may be substantially the same as the constituent elements of the vehicle drive device 100 illustrated in FIG. 1 are given the same reference numerals in FIG. 8 to omit their descriptions. Thus, the first oil passage 12, the second oil passage 32, the third oil passage 26, and the fourth oil passage 62 may be the same as those according to the embodiment discussed above.

The shell 30A is formed from two shell members 301 and 302. That is, the shell 30A has a structure in which the shell 30 (one member) of the first one-way clutch device 1 discussed above with reference to FIG. 1 etc. has been divided in the axial direction.

The second shell 60A is formed from two second shell members 601 and 602. That is, the second shell 60A has a structure in which the second shell 60 (one member) of the first one-way clutch device 1 discussed above with reference to FIG. 1 etc. has been divided in the axial direction.

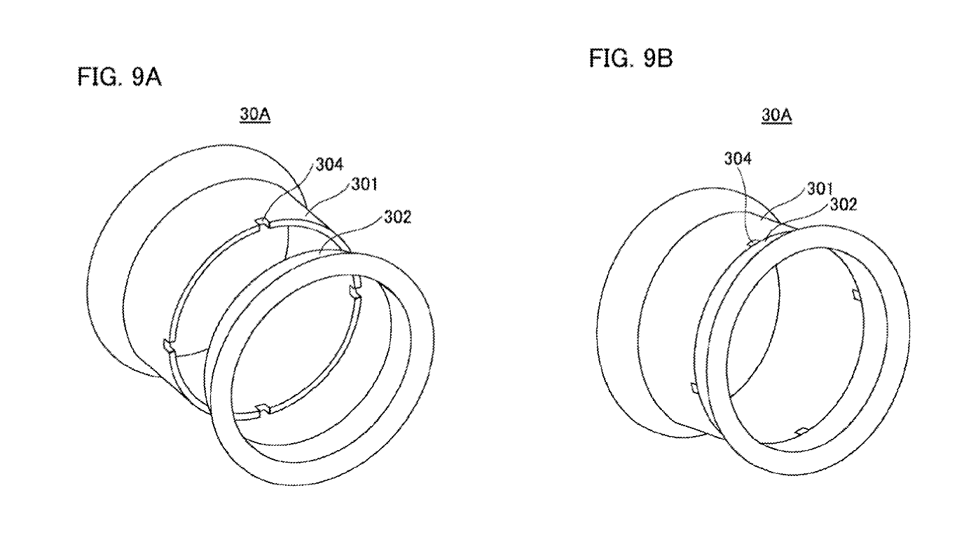

FIG. 9 illustrates an example of the shell 30A, in which FIG. 9A illustrates a state in which the two shell members 301 and 302 are separated in the axial direction and FIG. 9B illustrates a state in which the two shell members 301 and 302 are coupled to each other. In FIG. 9, the outer peripheral surface of the shell 30A is illustrated to be flat (with the inclined portion 34 not illustrated) for convenience.

As illustrated in FIG. 9, the shell 30A has a structure in which the two shell members 301 and 302 are disposed adjacent to each other in the axial direction. The shell members 301 and 302 are both press-fitted with the outer periphery of the first rotary member 10. The position of coupling (that is, position of division) between the shell members 301 and 302 in the axial direction may correspond to the position of formation of the second oil passage 32 in the axial direction. That is, a notch 304 for forming the second oil passage 32 is formed at an end portion (an end portion on the coupling side) of the shell member 301 in the axial direction. The notch 304 may be formed in both the shell members 301 and 302 or in only one of the shell members 301 and 302. It should be noted, however, that the notch 304 is preferably formed in the shell member 301 which is the longer of the shell members 301 and 302 in the axial direction. This is because the shell member 301 has a higher strength for its greater length than the shell member 302, and is less affected by a reduction in strength due to the presence of the notch 304. In the example illustrated in FIG. 9, the shell member 301 holds the roller 40 and the bearing 102 on the speed change mechanism 92 side, and the shell member 302 holds only the bearing 102 on the engine 90 side.

While only the structure of the shell 30A is illustrated in FIG. 9, the second shell 60A may have the same structure. That is, the second shell member 601 holds the roller 400 and the bearing 103 on the engine 90 side, and the second shell member 602 holds only the bearing 103 on the speed change mechanism 92 side. Thus, the second shell member 601 is formed to be longer in length in the axial direction than the second shell member 602, and a notch that is similar to the notch 304 is preferably formed on the second shell member 601 side.

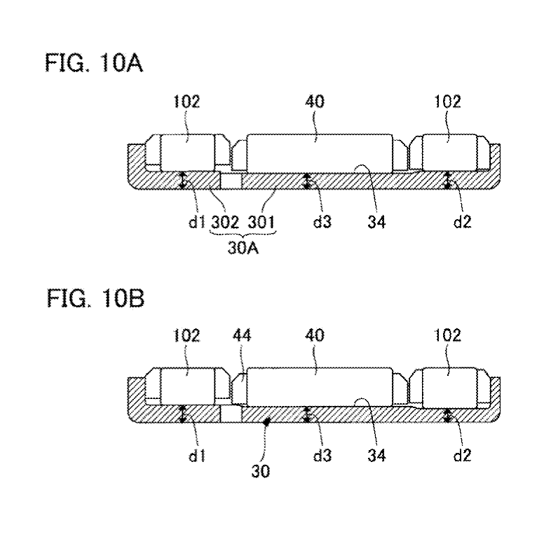

FIG. 10A illustrates a manner of variation in thickness of the shell 30A in the axial direction, and FIG. 10B illustrates a manner of variation in thickness of the shell 30 for comparison.

In the case of the shell 30 formed as one member, as illustrated in FIG. 10B, a thickness d3 of a region in the axial direction in which the inclined portion 34 is formed needs to be made larger than a thickness d2 of a region at an end portion that is adjacent in the axial direction. That is, the shell 30 has a thickness d1 in the region of the inner ring of the bearing 102 on the engine side, has a thickness d3 in the region in the axial direction in which the inclined portion 34 is formed, and has a thickness d2 in the region of the inner ring of the bearing 102 on the speed change mechanism side, with d1>d3>d2. This is attributable to restraints in processing for forming the inclined portion 34 around the center of the outer peripheral surface of the shell 30 in the axial direction. That is, this is because it is necessary to reduce the thickness of (thin down) the region of the inner ring of the bearing 102 on the speed change mechanism side to d2 after the inclined portion 34 is formed in the region in the axial direction in which the inclined portion 34 is to be formed. Therefore, in the case of the shell 30 formed as one member, as illustrated in FIG. 10B, the bearing 102 on the engine side and the bearing 102 on the speed change mechanism side do not have the same configuration, and there is a difference in diameter matching the difference between the thickness d1 and the thickness d2 between the bearing 102 on the engine side and the bearing 102 on the speed change mechanism side.

In the case of the shell 30A formed from two members (the two shell members 301 and 302), in contrast, as illustrated in FIG. 10A, the shell 30A has the same thickness d1, d2 in the region of the inner ring of the bearing 102 on the engine side and the region of the inner ring of the bearing 102 on the speed change mechanism side. That is, d1=d2>d3 is met. This is because the inclined portion 34 can be formed at an end portion of the outer peripheral surface of the shell member 301 and there are no restraints in processing such as those discussed above. Therefore, in the case of the shell 30A formed from two members (the two shell members 301 and 302), as illustrated in FIG. 10A, the bearing 102 on the engine side and the bearing 102 on the speed change mechanism side can have the same configuration. Consequently, it is possible to achieve commonality of parts, and to eliminate the need for design work such as adjusting loads to be carried by the bearing 102 on the engine side and the bearing 102 on the speed change mechanism side.

Although various embodiments have been discussed in detail above, the present invention is not limited to specific embodiments, and a variety of modifications and changes may be made without departing from the scope of the claims. In addition, all or a plurality of the constituent elements according to the embodiments discussed earlier may be combined with each other.

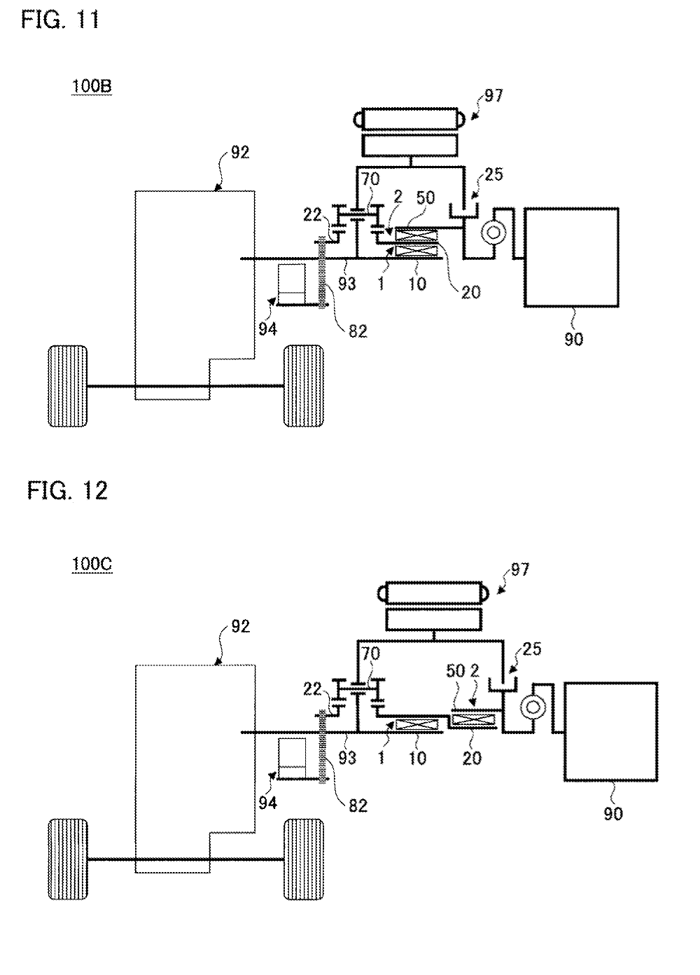

For example, in the first embodiment (and also the second embodiment) discussed above, the one-way clutch device 1 (and also the one-way clutch device 1A; the same applies hereinafter) is connected to the engine 90, and the one-way clutch device 2 (and also the one-way clutch device 2A; the same applies hereinafter) is connected to the motor 97. However, the connection relationship may be reversed as illustrated in FIGS. 11 and 12, for example. That is, the one-way clutch device 1 may be connected to the motor 97, and the one-way clutch device 2 may be connected to the engine 90.

Specifically, in a vehicle drive device 100B illustrated in FIG. 11, the one-way clutch device 1 and the one-way clutch device 2 are provided on the radially inner side and the radially outer side so as to face each other in the radial direction. The one-way clutch device 1 is disposed on the radially inner side of the one-way clutch device. The first rotary member 10 and the second rotary member 20 of the one-way clutch device 1 are connected to the input shaft 93 and the pump 94, respectively. The input shaft 93 is formed by the output shaft of the motor 97. The third rotary member 50 of the one-way clutch device 2 is connected to the engine 90. In the example illustrated in FIG. 11, the first rotary member 10 is coaxial with the input shaft 93, and the second rotary member 20 is connected to the pump 94 via a pinion gear 70, the sprocket 22, and the chain 82. The pinion gear 70 is provided to be rotatable, and to also revolve in accordance with rotation of the output shaft of the motor 97.

In a vehicle drive device 100C illustrated in FIG. 12, the one-way clutch device 1 and the one-way clutch device 2 do not face each other in the radial direction, and are provided apart from each other in the axial direction. The one-way clutch device 1 is disposed on the speed change mechanism 92 side with respect to the one-way clutch device. Similarly, the first rotary member 10 and the second rotary member 20 of the one-way clutch device 1 are connected to the input shaft 93 and the pump 94, respectively. The third rotary member 50 of the one-way clutch device 2 is connected to the engine 90.

The present international application claims priority to Japanese Patent Application No. 2013-090591 filed Apr. 23, 2013, the entire contents of which are incorporated herein by reference.

In relation to the embodiments described above, the following configurations are further disclosed.

(1) A one-way clutch device 1, 2, 1A, 2A including:

a radially inner rotary member (10, 20) having a first oil passage (12, 26) formed to extend in a radial direction;

a radially outer rotary member (20, 50) that rotates about a rotational axis about which the radially inner rotary member (10, 20) also rotates, the radially outer rotary member (20, 50) being disposed on a radially outer side with respect to the radially inner rotary member (10, 20);

a shell 30, 30A, 60 disposed between the radially inner rotary member (10, 20) and the radially outer rotary member (20, 50) in the radial direction and press-fitted with an outer periphery of the radially inner rotary member (10, 20), the shell 30, 30A, 60 having a second oil passage (32, 62) formed to extend in the radial direction to communicate with the first oil passage (12, 26) and an inclined portion 34, 340 formed on an outer peripheral surface of the shell 30, 30A, 60, a distance of the inclined portion 34, 340 from an inner peripheral surface of the radially outer rotary member (20, 50) in the radial direction being varied in a circumferential direction;

a roller 40, 400 housed between the inner peripheral surface of the radially outer rotary member (20, 50) and the inclined portion 34, 340 of the shell 30, 30A, 60;

an elastic member 42 that urges the roller 40, 400 toward a side toward which the distance of the inclined portion 34, 340 of the shell 30, 30A, 60 from the inner peripheral surface of the radially outer rotary member (20, 50) in the radial direction becomes smaller; and

a holder 44, 440 that holds the roller 40, 400 and the elastic member 42.

With the configuration described in (1), the radially outer rotary member (20, 50) and the radially inner rotary member (10, 20) are rotatable in the locked state. In addition, with the inclined portion 34, 340 formed on the shell 30, 30A, 60 to be press-fitted with the radially outer rotary member (20, 50), the shell 30, 30A, 60 can be press-fitted with the radially outer rotary member (20, 50) with the holder 44, 440 assembled to the shell 30, 30A, 60, which provides improved assemblability. Further, the first oil passage (12, 26) is formed in the radially inner rotary member (10, 20) to extend in the radial direction, and the second oil passage (32, 62) which communicates with the first oil passage (12, 26) is formed in the shell 30, 30A, 60 to extend in the radial direction. Thus, lubricating oil can be supplied to the roller 40, 400 from the radially inner side to the radially outer side. Consequently, the roller 40, 400 can be lubricated also in a configuration in which the shell 30, 30A, 60 is press-fitted with the outer periphery of the radially inner rotary member (10, 20).

(2) The one-way clutch device 1, 2, 1A, 2A according to (1), further including:

a bearing 102, 103 disposed between the shell 30, 30A, 60 and the radially outer rotary member (20, 50) in the radial direction and disposed adjacent to the roller 40, 400 in an axial direction, in which

an opening of the second oil passage (32, 62) on the radially outer side is positioned between the roller 40, 400 and the bearing 102, 103 in the axial direction.

With the configuration described in (2), the second oil passage (32, 62) can be formed utilizing a region in the axial direction in which the roller 40, 400 or the bearing 102, 103 is not provided. That is, the second oil passage (32, 62) can be formed while substantially maintaining the required strength of the shell 30, 30A, 60. In addition, the entire roller 40, 400 can be lubricated.

(3) The one-way clutch device 1, 2, 1A, 2A according to (1) or (2), in which

an opening of the second oil passage (32, 62) on a radially inner side and an opening of the first oil passage (12, 26) on the radially outer side are formed at the same position in the axial direction.

With the configuration described in (3), the first oil passage (12, 26) and the second oil passage (32, 62) can efficiently communicate with each other.

(4) The one-way clutch device 1, 2, 1A, 2A according to any one of (1) to (3), in which

the first oil passage (12, 26) and the second oil passage (32, 62) communicate with each other via an annular oil passage 13, 23 formed in the outer peripheral surface of the radially inner rotary member (10, 20).

With the configuration described in (4), the first oil passage (12, 26) and the second oil passage (32, 62) can communicate with each other via the annular oil passage 13, 23 even in the case where the shell 30, 30A, 60 is press-fitted with the radially inner rotary member (10, 20) with such an angular relationship that the first oil passage (12, 26) and the second oil passage (32, 62) do not face each other in the radial direction.

(5) The one-way clutch device 1, 2, 1A, 2A according to any one of (1) to (3), in which:

a plurality of first oil passages (12, 26) are formed along a circumferential direction of the radially inner rotary member (10, 20);

a plurality of second oil passages (32, 62) are formed along a circumferential direction of the shell 30, 30A, 60; and

the plurality of first oil passages (12, 26) and the plurality of second oil passages (32, 62) are formed such that at least one set of a first oil passage (12, 26) and a second oil passage (32, 62) communicate with each other at any rotational position of the shell 30, 30A, 60 with respect to the radially inner rotary member (10, 20).

With the configuration described in (5), the first oil passage (12, 26) and the second oil passage (32, 62) can communicate with each other irrespective of the angular relationship with which the shell 30, 30A, 60 is press-fitted with the radially inner rotary member (10, 20).

(6) The one-way clutch device 1, 2, 1A, 2A according to any one of (1) to (5), in which:

the shell 30A is formed from two shell members 301, 302 with different lengths in the axial direction; and

a notch 304 that defines the second oil passage (32, 62) is formed in one 301 of the two shell members 301, 302 that is the longer in the axial direction.

With the configuration described in (6), it is possible to achieve commonality of parts, and to eliminate the need for design work such as adjusting loads to be carried by the bearings 102, 103.

(7) A one-way clutch device 1, 2, 1A, 2A including:

the one-way clutch device according to any one of (1) to (6) serving as a first one-way clutch device 1, 1A; and

a second one-way clutch device 2, 2A, in which:

one of the radially inner rotary member (10) and the radially outer rotary member (20) of the first one-way clutch device 1, 1A is connected to one of an engine 90 and a motor 97, and the other of the radially inner rotary member (10) and the radially outer rotary member (20) of the first one-way clutch device 1, 1A is connected to an oil pump (94); and

the second one-way clutch device 2, 2A includes a radially inner rotary member (20) and a radially outer rotary member (50), one of the radially inner rotary member (20) and the radially outer rotary member (50) of the second one-way clutch device 2, 2A is connected to the other of the engine 90 and the motor 97, and the other of the radially inner rotary member (20) and the radially outer rotary member (50) of the second one-way clutch device 2, 2A is connected to the oil pump (94).

With the configuration described in (7), the two one-way clutch devices 1, 2, 1A, 2A cooperate with each other so that the oil pump (94) can be driven by one of the engine 90 and the motor 97 with a higher rotational speed.

(8) A one-way clutch device 1, 2, 1A, 2A including:

the one-way clutch device 1, 2, 1A, 2A according to (2) serving as a first one-way clutch device 1, 1A; and

the one-way clutch device 1, 2, 1A, 2A according to (2) serving as a second one-way clutch device 2, 2A, in which:

the second one-way clutch device 2, 2A is disposed on a radially outer side of the first one-way clutch device 1, 1A in such a manner that the radially inner rotary member (20) of the second one-way clutch device 2, 2A serves as the radially outer rotary member (20) of the first one-way clutch device 1, 1A;

the roller 40 of the first one-way clutch device 1, 1A is provided at the same position in the axial direction as the roller 400 of the second one-way clutch device 2, 2A;

an opening of the second oil passage 32, on the radially outer side, of the first one-way clutch device 1, 1A is positioned between one side of the roller 40 of the first one-way clutch device 1, 1A and the bearing 102 of the first one-way clutch device 1, 1A in the axial direction; and

an opening of the second oil passage (62), on the radially outer side, of the second one-way clutch device 2, 2A is positioned between the other side of the roller 400 of the second one-way clutch device 2, 2A and the bearing 103 of the second one-way clutch device 2, 2A in the axial direction.

With the configuration described in (8), the rollers 40, 400 of the two one-way clutch devices 1, 2, 1A, 2A can be easily lubricated uniformly.

### DESCRIPTION OF THE REFERENCE NUMERALS

1, 2, 1A, 2A ONE-WAY CLUTCH DEVICE
10 FIRST ROTARY MEMBER
11 SHAFT
12 FIRST OIL PASSAGE
13 OIL PASSAGE
14 OIL PASSAGE
15 OIL PASSAGE
20 SECOND ROTARY MEMBER
22 SPROCKET
23 OIL PASSAGE
26 THIRD OIL PASSAGE
30, 30A SHELL
301, 302 SHELL MEMBER
304 NOTCH
32 SECOND OIL PASSAGE
34, 340 INCLINED PORTION
40, 400 ROLLER
42 ELASTIC MEMBER
44, 440 HOLDER
50 THIRD ROTARY MEMBER
60 SECOND SHELL
601, 602 SHELL MEMBER
62 FOURTH OIL PASSAGE
80 PUMP DRIVE SHAFT
82 CHAIN
90 ENGINE
92 SPEED CHANGE MECHANISM
93 INPUT SHAFT
94 PUMP
95 CLUTCH
97 MOTOR
100, 100A VEHICLE DRIVE DEVICE
102, 103 BEARING

1-8. (canceled)

9. A one-way clutch device comprising:
a radially inner rotary member having a first oil passage formed to extend in a radial direction;
a radially outer rotary member that rotates about a rotational axis about which the radially inner rotary member also rotates, the radially outer rotary member being disposed on a radially outer side with respect to the radially inner rotary member;
a shell disposed between the radially inner rotary member and the radially outer rotary member in the radial direction and press-fitted with an outer periphery of the radially inner rotary member, the shell having a second oil passage formed to extend in the radial direction to communicate with the first oil passage and an inclined portion formed on an outer peripheral surface of the shell, a distance of the inclined portion from an inner peripheral surface of the radially outer rotary member in the radial direction being varied in a circumferential direction;
a roller housed between the inner peripheral surface of the radially outer rotary member and the inclined portion of the shell;
an elastic member that urges the roller toward a side toward which the distance of the inclined portion of the shell from the inner peripheral surface of the radially outer rotary member in the radial direction becomes smaller; and
a holder that holds the roller and the elastic member.

10. The one-way clutch device according to claim 9, further comprising:
a bearing disposed between the shell and the radially outer rotary member in the radial direction and disposed adjacent to the roller in an axial direction, wherein
an opening of the second oil passage on the radially outer side is positioned between the roller and the bearing in the axial direction.

11. The one-way clutch device according to claim 9, wherein
an opening of the second oil passage on a radially inner side and an opening of the first oil passage on the radially outer side are formed at the same position in the axial direction.

12. The one-way clutch device according to claim 9, wherein
the first oil passage and the second oil passage communicate with each other via an annular oil passage formed in the outer peripheral surface of the radially inner rotary member.

13. The one-way clutch device according to claim 9, wherein:
a plurality of first oil passages are formed along a circumferential direction of the radially inner rotary member;
a plurality of second oil passages are formed along a circumferential direction of the shell; and
the plurality of first oil passages and the plurality of second oil passages are formed such that at least one set of a first oil passage and a second oil passage communicate with each other at any rotational position of the shell with respect to the radially inner rotary member.

14. The one-way clutch device according to claim 9, wherein:
the shell is formed from two shell members with different lengths in the axial direction; and
a notch that defines the second oil passage is formed in one of the two shell members that is the longer in the axial direction.

15. A drive device comprising:
a first one-way clutch device including the structure of the one-way clutch device according to claim 9; and
a second one-way clutch device, wherein:
one of the radially inner rotary member and the radially outer rotary member of the first one-way clutch device is connected to one of an engine and a motor, and the other of the radially inner rotary member and the radially outer rotary member of the first one-way clutch device is connected to an oil pump; and
the second one-way clutch device includes a radially inner rotary member and a radially outer rotary member, one of the radially inner rotary member and the radially outer rotary member of the second one-way clutch device is connected to the other of the engine and the motor, and the other of the radially inner rotary member and the radially outer rotary member of the second one-way clutch device is connected to the oil pump.

16. The one-way clutch device according to claim 10, wherein
an opening of the second oil passage on a radially inner side and an opening of the first oil passage on the radially outer side are formed at the same position in the axial direction.

17. The one-way clutch device according to claim 10, wherein
the first oil passage and the second oil passage communicate with each other via an annular oil passage formed in the outer peripheral surface of the radially inner rotary member.

18. The one-way clutch device according to claim 10, wherein:
a plurality of first oil passages are formed along a circumferential direction of the radially inner rotary member;
a plurality of second oil passages are formed along a circumferential direction of the shell; and
the plurality of first oil passages and the plurality of second oil passages are formed such that at least one set of a first oil passage and a second oil passage communicate with each other at any rotational position of the shell with respect to the radially inner rotary member.

19. The one-way clutch device according to claim 10, wherein:
the shell is formed from two shell members with different lengths in the axial direction; and
a notch that defines the second oil passage is formed in one of the two shell members that is the longer in the axial direction.

20. A drive device comprising:
a first one-way clutch device; and
a second one-way clutch device, wherein:
both of the first one-way clutch device and the second one-way clutch device include the structure of the one-way clutch device according to claim 10;
the second one-way clutch device is disposed on a radially outer side of the first one-way clutch device in such a manner that the radially inner rotary member of the second one-way clutch device serves as the radially outer rotary member of the first one-way clutch device;
the roller of the first one-way clutch device is provided at the same position in the axial direction as the roller of the second one-way clutch device;
an opening of the second oil passage, on the radially outer side, of the first one-way clutch device is positioned between one side of the roller of the first one-way clutch device and the bearing of the first one-way clutch device in the axial direction; and
an opening of the second oil passage, on the radially outer side, of the second one-way clutch device is positioned between the other side of the roller of the second one-way clutch device and the bearing of the second one-way clutch device in the axial direction.

21. The one-way clutch device according to claim 16, wherein
the first oil passage and the second oil passage communicate with each other via an annular oil passage formed in the outer peripheral surface of the radially inner rotary member.

22. The one-way clutch device according to claim 16, wherein:
a plurality of first oil passages are formed along a circumferential direction of the radially inner rotary member;
a plurality of second oil passages are formed along a circumferential direction of the shell; and
the plurality of first oil passages and the plurality of second oil passages are formed such that at least one set of a first oil passage and a second oil passage communicate with each other at any rotational position of the shell with respect to the radially inner rotary member.

23. The one-way clutch device according to claim 16, wherein:
the shell is formed from two shell members with different lengths in the axial direction; and
a notch that defines the second oil passage is formed in one of the two shell members that is the longer in the axial direction.

24. The one-way clutch device according to claim 11, wherein
the first oil passage and the second oil passage communicate with each other via an annular oil passage formed in the outer peripheral surface of the radially inner rotary member.

25. The one-way clutch device according to claim 11, wherein:
a plurality of first oil passages are formed along a circumferential direction of the radially inner rotary member;
a plurality of second oil passages are formed along a circumferential direction of the shell; and
the plurality of first oil passages and the plurality of second oil passages are formed such that at least one set of a first oil passage and a second oil passage communicate with each other at any rotational position of the shell with respect to the radially inner rotary member.

26. The one-way clutch device according to claim 11, wherein:
the shell is formed from two shell members with different lengths in the axial direction; and
a notch that defines the second oil passage is formed in one of the two shell members that is the longer in the axial direction.

27. The one-way clutch device according to claim 12, wherein:
the shell is formed from two shell members with different lengths in the axial direction; and
a notch that defines the second oil passage is formed in one of the two shell members that is the longer in the axial direction.

28. The one-way clutch device according to claim 13, wherein:
the shell is formed from two shell members with different lengths in the axial direction; and
a notch that defines the second oil passage is formed in one of the two shell members that is the longer in the axial direction.
